(19) United States
(12) Patent Application Publication
(10) Pub. No.: US 2002/0152110 A1
(43) Pub. Date: Oct. 17, 2002

(54) Method and system for collecting market research data

(76) Inventors: Betsy J. Stewart, Lake Quivira, KS (US); Roderick Bennett, Olathe, KS (US); Sonja Hitchcock, Kansas City, MO (US)

Correspondence Address: Jordan A. Sigale, Sonnenschein Nath & Rosenthal, P.O. Box 061080, Wacker Drive Station, Sears Tower, Chicago, IL, 60606-1080, US

(21) Appl. No.: 09/835,608

(22) Filed: Apr. 16, 2001

(51) Int. Cl. G06F 17/60

(52) U.S. Cl. 705/10

(57) ABSTRACT

The present invention provides a system for collecting market research data on-line through the use of a Web-hosted interactive multi-media software application. This system collects participants' responses and reactions to pre-determined stimuli utilizing interactive participation via computers to collect data while adhering to scientific and proven market research methodologies. When the system is hosted on a web accessible resource, participants access the system via unique universal resource locators (URLs). Such responses are recorded, scored and stored in a text file in a hidden frame that remains state throughout the execution of the survey. Once all the responses are scored and stored, the text in the hidden frame is then sent to the administrator's server for storage and subsequent analysis.

### FIELD OF THE INVENTION

The present invention relates generally to a method and system for collecting market research data on a personal computer (“PC”), and more specifically, a method and system for collecting market research data through a structured and controlled multi-media interactive network-hosted software application that incorporates complex market research methodologies.

### BACKGROUND OF THE INVENTION

Currently, software developed for collecting market research data via a personal computer (“PC”) is comprised of static surveys that collect text responses or data from the person taking the survey, e.g., the potential consumer. The focus of these static surveys has been on collecting the data quickly rather than on the science associated with the manner in which such information is collected.

Such static surveys are primarily formatted to be multiple choice questions or questions that ask the participant to describe their reactions to certain photographs or illustrations. By using such static surveys to collect market data, much of the intelligence in collecting market research data is removed, which results in the collection of superficial information only, which is often inaccurate and unreliable.

The intelligence that is missing from such static surveys is the ability to capture the true reaction of a participant from the stimuli that is presented to such participant. The true reaction represents that participant's most likely response and behavior in a real-life situation. Static surveys by their nature do not allow the taker to interact with and alter the stimuli, and thus, additional information about needs and wants of consumers cannot be analyzed. Rather, a participant is asked to gauge his or her own response to merely text or inanimate objects and then document that response by answering a multiple choice question or describing his or her response in a text box. Thus, currently available PC-based market surveys do not independently gauge a survey taker's response, but capture canned responses that reflect the surveyor's interpretations of participant's responses.

Interactive programming tests multiple variables more effectively and efficiently than other survey methods, such as traditional paper and pencil methods, telephone or mail because it allows the surveys to incorporate randomization, skip patterns, rotations, branching and most importantly real-time customization. Interactive programming also allows greater control over sampling or survey bias, user preferences and “no answers.” These survey techniques are more easily incorporated into a survey using multi-media tools to collect participant data.

Further, consumers and business decision-makers are bombarded minute-by-minute with stimuli that asks them to buy or use a product or service. In fact, research has shown that the average resident of the U.S. receives 1,700 such messages every hour of every day. Survey research should mirror live and realistic situations as much as possible to interpret potential buyers' behavior, feelings and beliefs about these stimuli. Thus, there is a need for interactive multi-media survey methods especially where such methods reflect real life scenarios.

### SUMMARY OF THE INVENTION

A number of the needs are met and technical advances are achieved in the art, by providing a system and method for collecting data through the use of dynamic multi-media tools. These multi-media tools may actually engage most of the participant's senses and ask questions based on stimuli that more accurately reflect an actual product through the use of virtual display, virtual tours or other similar depictions of actual objects and data. With more accurate data collection, advanced statistical models can more accurately analyze and extrapolate the collected data to produce unbiased, reliable information.

More particularly, the present invention provides for a multi-media interactive network-hosted software application for performing on-line market research surveys. The application of the present invention incorporates complex market research methodologies by allowing a survey participant to interact directly with the stimuli such that the participant's reaction to the stimuli can be captured without requiring the participant to interpret his or her own responses, e.g., by allowing the participant to manipulate the stimuli to respond to questions without always recording a number or similar cognitive response.

The present invention further captures responses from the participants as the participant manipulates such stimuli, scores such responses and stores such responses in a hidden frame as HTML with hidden input tags. This allows the responses to be stored in a data frame on the participant's computer until all the responses are collected. At the conclusion of the survey the stored input is sent to the server, as text (preferably comma-delimited). The stored responses can then be written and used by any program that has the capability to manipulate the text data. In this manner, data is not written to the server and stored for analysis unless and until, the participant has completed the entire survey.

In a preferred approach, the invention provides for multi-media stimuli to reach a breadth of senses. For instance, the invention may use audio so as to have the participant listen to interviewing instructions or introduction of a new product idea (may be combined with visual stimuli (i.e. pictures, video and music). In another option, the participant may watch and listen to a test advertisement. In yet another example, a typical store shelf could be mocked-up for the participant to click on desired purchases and watches his/her purchase amount tally on-screen. These many techniques enable the surveyor to reach many different types of respondents and in many different ways of teaching and learning. These psychosocial testing patterns enable a much deeper and more accurate level of response than would have been possible using traditional and current techniques. This method comprises: (a) providing a browasable computer resource accessible by said participant through a communications link; (b) initiating an electronic survey when said participant accesses said computer resource; (c) allowing said participant to manipulate a graphical item as part of said electronic survey; (d) generating data based upon said manipulation of said graphical item; repeating (c) and (d) until the electronic survey is complete; and (e) storing said data. The manipulation is selected from the group comprising rotating, magnifying, moving, and visually changing said graphical item.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a high-level architectural drawing illustrating the primary components of a system that operates in accordance with one embodiment of the present invention.

FIG. 2 is block diagram illustrating one embodiment of the system of the present invention.

FIG. 3 is a block diagram illustrating one embodiment of the method of the present invention.

FIG. 4 illustrates a browser window of one embodiment of the present invention containing a customized frame set containing a main frame that is used to display the various survey modules illustrated in FIGS. 5-22 and a navigational frame that stores client-side state and is “hidden” throughout the survey and which contains a series of fields that store data generated by the responses contained in the main window.

FIG. 5 illustrates a text response survey module of one embodiment of the present invention.

FIG. 6 illustrates a multiple choice, single response survey module of one embodiment of the present invention.

FIG. 7 illustrates a single response, real time feedback survey module of one embodiment of the present invention that allows the participant to vary the colors of an object.

FIG. 8 illustrates a drop and drag, multiple response survey module of one embodiment of the present invention that allows the participant to position, affix or affiliate various objects with an article or person.

FIG. 9 illustrates the survey module of FIG. 4 with the various items affiliated with or affixed to two people.

FIG. 10 illustrates that the items of FIG. 4 may be arranged differently than the items shown in FIG. 5 as they are affiliated with or affixed to the two people.

FIG. 11 illustrates a slider scale response survey module of one embodiment of the present invention that allows the participant to drag a slider to indicate the level of appeal to the participant of the object in the picture.

FIG. 12 illustrates a multiple response, interactive check box survey module of one embodiment of the present invention that allows the participant to decorate an object in a manner that appeals to the participant.

FIG. 13 illustrates the survey module of FIG. 8 with the object decorated with one set of attributes.

FIG. 14 illustrates the survey module of FIG. 9 with the object decorated with another set of attributes.

FIG. 15 illustrates a multiple response, custom calculation survey module of one embodiment of the present invention that allows a participant to customize an item to reduce the cost of such item.

FIG. 16 illustrates the test module of FIG. 15 with two features of the item removed to reduce the cost of such item.

FIG. 17 illustrates a timer interaction survey module of one embodiment of the present invention that grants a participant a set period of time to select between at least two activities to determine which activity is more appealing to the participant.

FIG. 18 illustrates a drop and drag, variable scale response survey module of one embodiment of the present invention that allows a participant to drag a sliding scale to allocate points between two products.

FIG. 19 illustrates an allocation survey module of one embodiment of the present invention that allows a participant to allocate a total number of points between four components.

FIG. 20 illustrates a ranking survey module of one embodiment of the present invention that allows a participant to drag colors and patterns and drop them on a scale according to preference.

FIG. 21 illustrates a purchase history survey module of one embodiment of the present invention that allows a participant to visually identify products that the participant has purchase in the past.

FIG. 22 illustrates a user preference survey module of one embodiment of the present invention that allows a participant to select objects in order of preference.

FIG. 23 illustrates a drop and drag, sort survey module of one embodiment of the present invention that allows a participant to drag colors and patterns and drop them on a scale according to preference.

FIG. 24 is one embodiment of a computer system implementing the method and system of the present invention.

### DETAILED DESCRIPTION

While the present invention may be embodied in many different forms, several specific embodiments are discussed herein with the understanding that the present disclosure is to be considered only as an exemplification of the principles of the invention, and it is not intended to limit the invention to the embodiments illustrated.

A. System 30

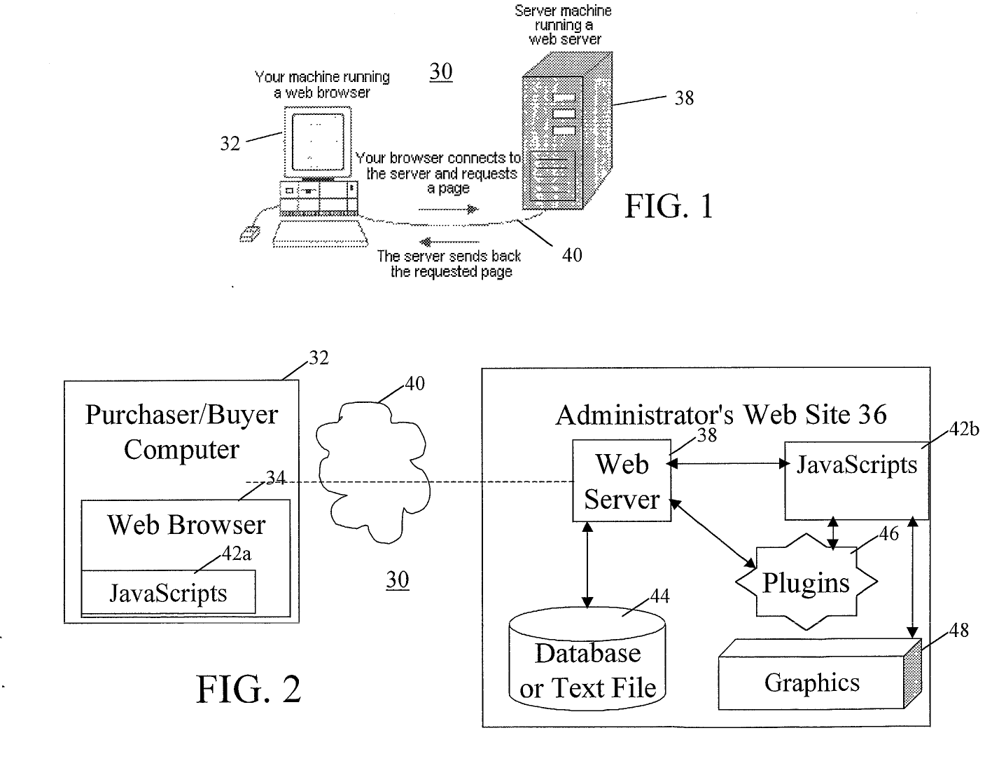

FIGS. 1 and 2 illustrate the general high level architecture of the market research system 30 of the present invention. In one embodiment, the system 30 includes a Participant's computer 32, having a Web browser 34, and a Web site 36 operating on a server 38. For purposes of this discussion, a “Participant” will be known herein as the person who is engaged by the market research system for the purpose of recording the person's response to certain predetermined stimuli. An “Administrator” is the person or entity that is utilizing the market research system to collect information from Participants.

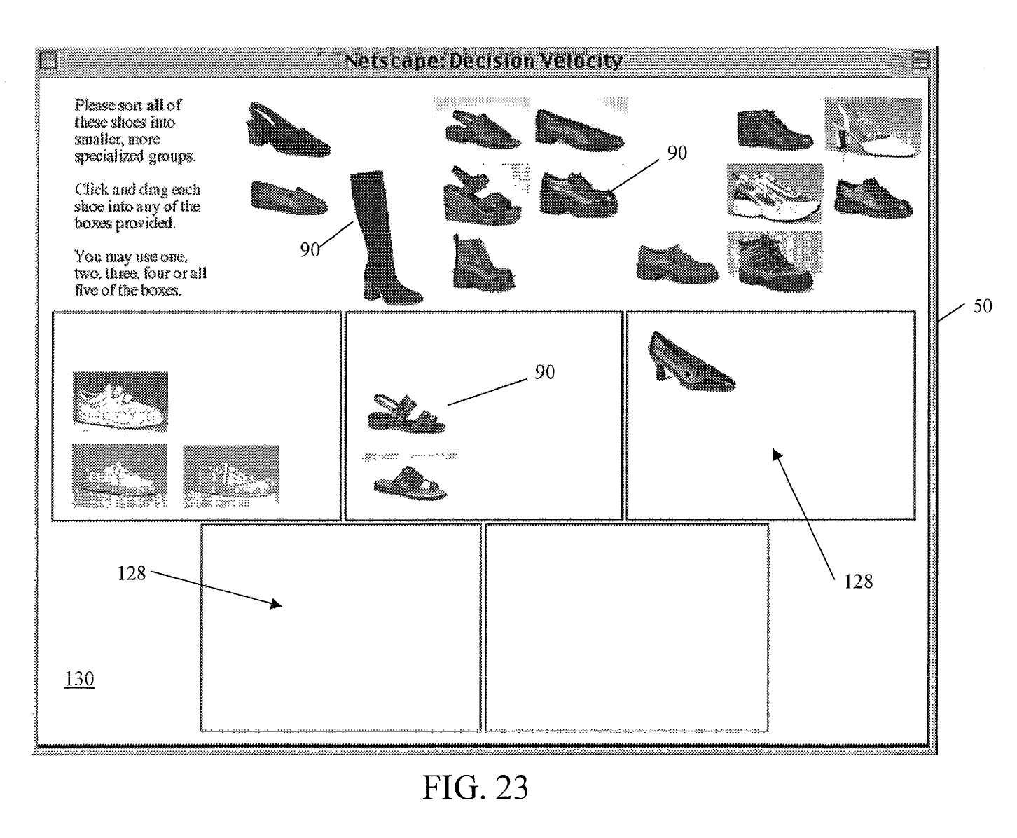

Participant's computer 32 may be any type of computer device that allows Participant to interactively browse Web sites via a Web browser, such as Netscape Navigator version 4.x or Microsoft Internet Explorer version 4.x. For example, such computer may be a personal computer (“PC”) that runs on a Windows NT operating system. Further discussion of such computer system may be found below with reference to FIG. 23.

In the preferred embodiment, the present invention is provided through a Web site 36, operating on a server 38, that is accessible by Participants via any data network or communications link 40, such as the Internet or other data network that transmits data or instructions. Participants utilize their computers 32, which are also referred to as clients, to communicate with the Web server 38 using HTTP (Hyper-Text Transport Protocol) and HTTPS (secure HTTP) protocols or other similar protocols. The Web server 38 accesses a local store of Java Script-enabled HTML pages 42 (Web pages) which are requested, retrieved, and viewed by the Participants using their Web browsers 34. As would be understood to those of skill in the art, other authoring languages may be used. The server system 30, includes a server engine (not shown), various Java Script Pages 42 and at least one database 44 used to store the information collected from the Participants by the system 30. The server 38 and client 32 interact and exchange information via a communications link 40, which may include, among other things, transmission over the Internet.

In the preferred embodiment, the Web site 36 provides various survey modules 50 for recording Participant's responses to various pre-determined stimuli. The Web site 36 will typically be developed by a group of market research experts, which are referred to herein as the Administrator.

As described in more detail below, the Web site 36 includes several survey modules 50, which comprise various interactive graphics, video and real audio that incorporates a variety of market research methodologies. Such survey modules 50 allow the Administrator to perform price sensitivity research for market segmentation, to perform conjoint and discrete choice studies, to develop visitor profiles, and to evaluate customer satisfaction, new products, and product awareness and usage.

One skilled in the market research art will recognize that the present invention can be tailored to assist in procuring a wide variety of information from consumers, professionals, or other target audiences and is not limited to use in connection with market research studies. For example, the system of the present invention could be used to collect and analyze employee satisfaction within a company, profiles of trade show attendess, or reasons for funding among college alumni. For purposes of this discussion, the present invention will be described as if the system would be customized and implemented for the procurement of market research information.

B. Market Research Application 60

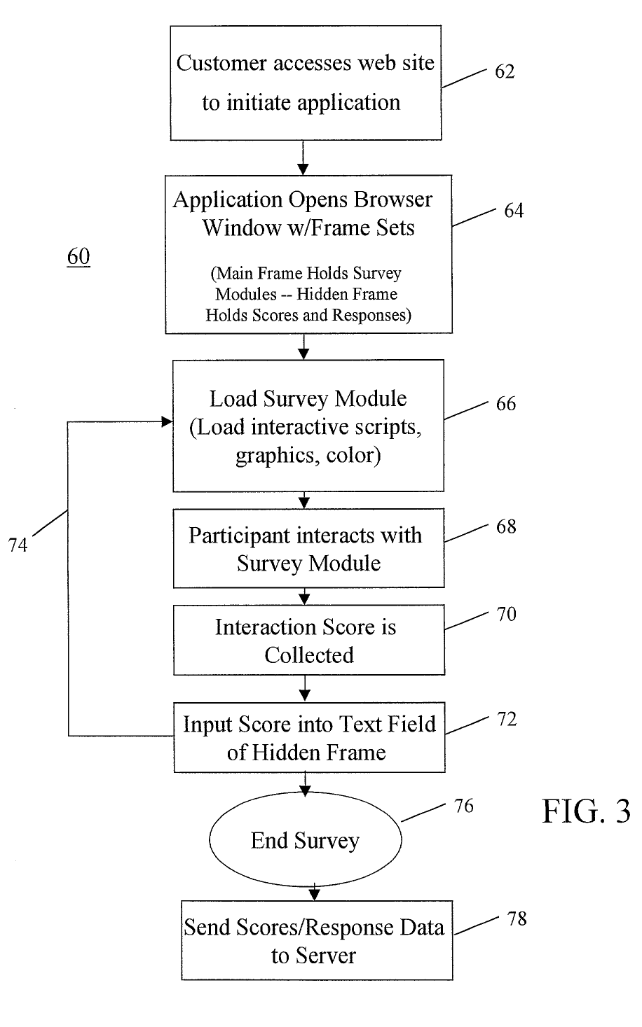

As illustrated by FIG. 3, in the preferred embodiment of the present invention, to initiate the survey 62, a Participant first accesses the market research application 60 of the present invention through any data network or communications link 40, but preferably through the Internet. A Participant may be directed to the market research application through a link that is provided to the Participant via e-mail or other communication, or may be directed to the market research application through a hyper-link from another Web site.

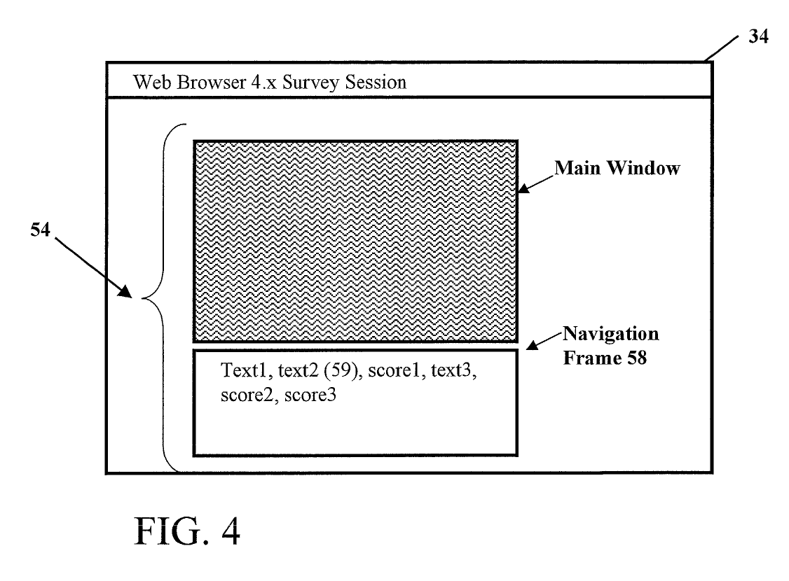

As illustrated by FIG. 3, when the survey 62 is initiated 64, the HTML documents launch a browser window 52 that is viewed by a Participant on its computer 32. As shown in FIG. 4, in one embodiment, the browser window 52 contains a customized frame set 54 (having two windows in the case of FIG. 4, but the number of windows in the set is constrained solely by the browser). The top or main frame 56 is used to display the survey modules 50 and to interact with the Participant. As such, the main frame will be changing throughout a session and, thus, the frame will be collapsed as is standard with JavaScript functionality. When a frame is collapsed all of its data is collapsed. Nevertheless, for purposes of taking a survey the responses and other data gleaned from the Participants interaction with the main frame needs to be preserved. Rather, than dynamically store the data on the server side, the data (i.e. “state”) is stored and maintained in the data frame 58 via hidden input (text) fields. The data frame is maintained open throughout the Participant's session, but “hidden” below the main frame 56. “Hidden” for purposes of this application means not readily noticeable. In particular, in a preferred approach, the navigation frame is hidden by assigning an almost imperceptibly small size to the navigation frame, effectively hiding it. Alternatively, the frame could be assigned to an x, y-coordinate that is outside the active potion of the browser, thus, making the frame imperceptible to the user.

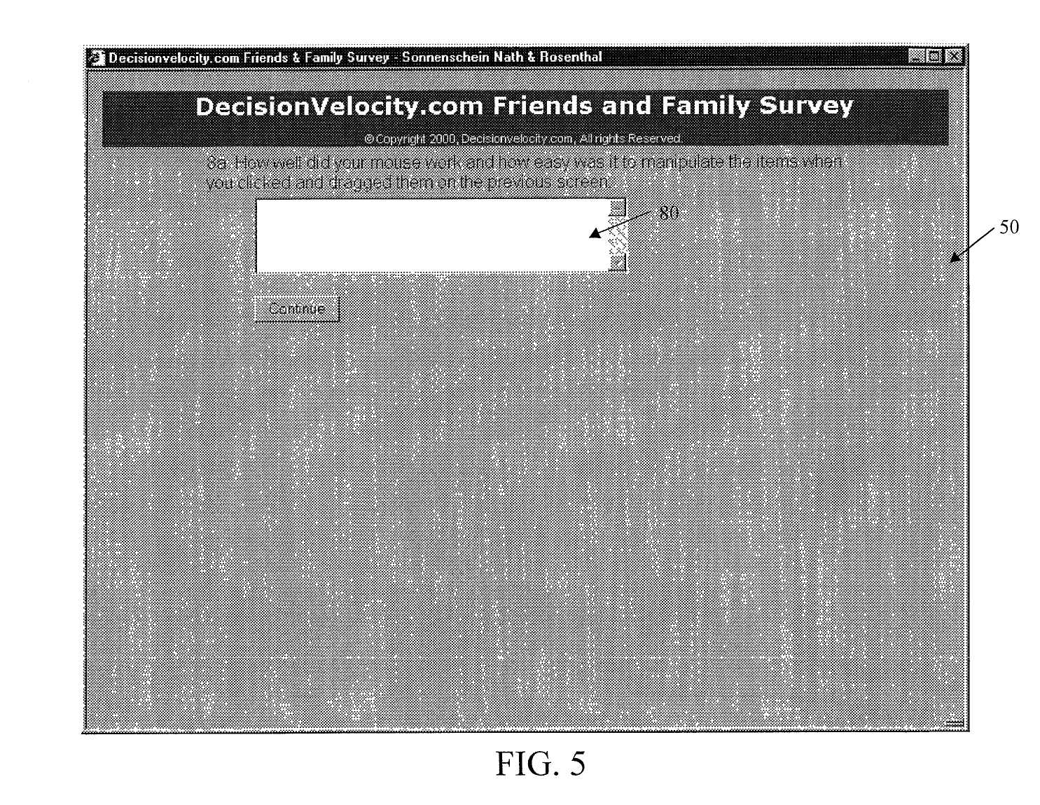

As discussed above, the market research application 60 of the present invention then loads a series of web pages (HTML documents) 66. These web pages are loaded in the main frame 56 of the browser window frame set 54 and represent various testing or survey modules 50 that employ a variety of market research methodologies. As seen in FIGS. 5-23, such web pages generally consist of (i) a variety of different question types, including yes or no questions and multiple choice, (ii) rating scales, (iv) comment boxes, and (v) multi-media interactive components (collectively “survey modules 50”). These HTML documents utilize customized client-side JavaScripts 42a alone or in combination with pre-existing JavaScripts stored server-side 42b designed and developed by Macromedia and made available through any of the following products: Coursebuilder, Flash and Dreamweaver 3 and 4 (and its extensible objects). Other tools that may be used in the design of the HTML documents include: Allaire Homesite, Adobe Photoshop, Adobe ImageReady, Microsoft Visual Interdev, and Front Page 2000.

As each survey module 50 is displayed, the Participant is asked to interact with the survey module 50 by manipulating the stimuli, responding to questions or entering text. A score (not shown) is then generated 70 from Participant's interaction with each module 50. Before moving to the next module 50, some data or the score for that particular module 50 is then entered (FIG. 3, step 72) into a pre-designated text field 59 in the data frame 58 for that specific survey module 50. This process is then repeated with the next survey module 50 until all the survey modules for a particular study have been displayed 74 and all the responses for each module 50 have been stored in the data frame 58. At that time, the Participant ends the survey 76 (e.g. by clicking a Finish button) and the text in the data frame 58 is sent to the administrator's server 38 for permanent storage as a text file or in a database application 44 of administrator's choice, step 78. In a preferred approach, a client-side Javascript is invoked that activates a server-side script that takes that data in the data frame 58 as a text file and writes that text file to the selected database. This transfer may be accomplished using “Common Gateway Interface” method.

C. Survey Modules 50

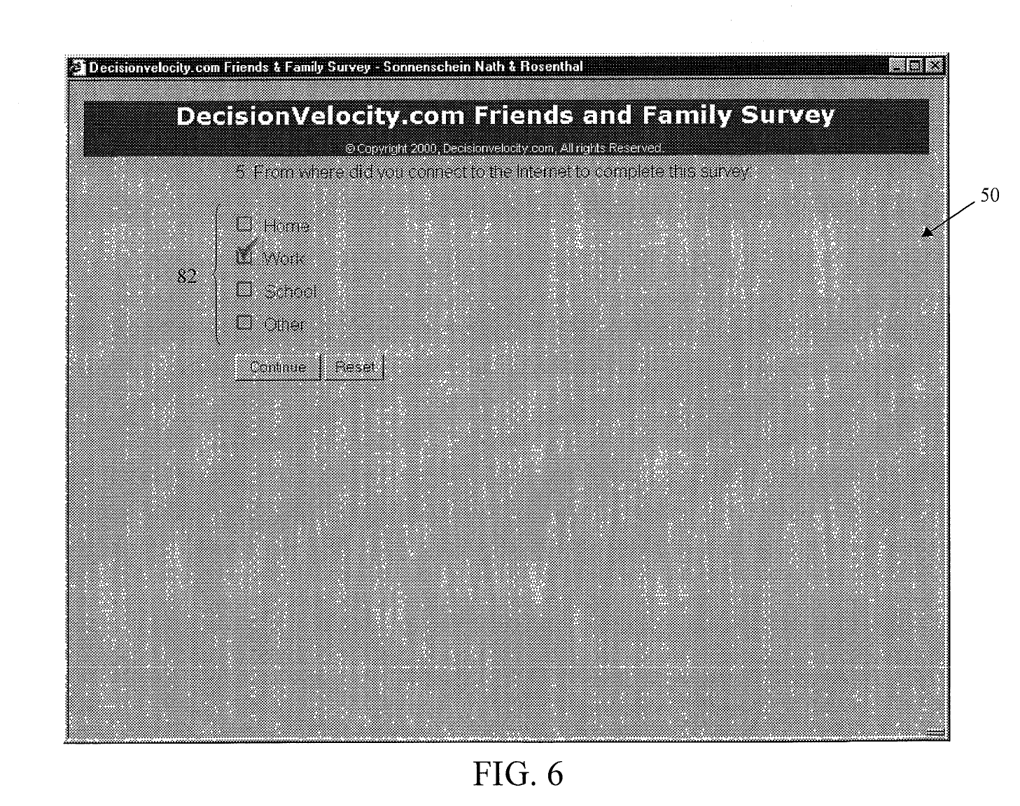

As with most market research studies, the market research application of the present invention begins by collecting various demographic information from a Participant, such as age, gender, household income and etc. This information is typically collected by checking the appropriate box or typing in a text response. FIG. 5 illustrates a Web page that ask a Participant to type a response to a question in a text box 80. Alternatively, FIG. 6 illustrates a Web page seeking a Participant to check one of a number of boxes 82 in response to a multiple choice question.

Once the demographic information is collected, the application then commences gathering a Participant's response to certain stimuli through the use of multi-media interactive components, such as graphics, video, audio applets using JAVA, Flash and real audio. These interactive components are displayed to a Participant through Web pages viewed by the Participant through his or her Browser. To increase the accuracy of the survey results and to prevent a Participant from responding too soon to any one module, in one embodiment of the present invention, the application overlays a layer over the Web page that is loading the graphic. The application then removes the layer after the graphics on the underlying page have finished loading. In the preferred embodiment, such layer is a solid colored layer that is (i) the same color as the background of the underlying web page, (ii) absent any borders and (iii) sized only to fit directly over only the portion of the underlying Web page that is loading the graphics. Thus, a Participant will not be able to distinguish between the layer and underlying web pages. This functionality is enabled by the pre-selection of a level 4 or better browser in the scripts stored in the first survey HTML page. Participant browsers that are less than a level 4 are asked to upgrade their browser before participating. This is required by the level 4 specific browser functionality built into the survey technology. One example being this use of masking layers in the description of the overlay layer above.

A wide variety of multi-media interactive components can be utilized to collect market research data. This variety of multi-media interactive components shall be referred to herein as survey modules 50. In one embodiment of the present invention, these survey modules 50 can be categorized as follows: (i) Single Response—Real Time Feedback; (ii) Drop & Drag—Multiple Response; (iii) Slider Scale Response; (vi) Multiple Response—Interactive Checkbox; (v) Multiple Response—Custom Calculation Features; (vi) Timer Interaction; (vii) Drop & Drag—Variable Scale Response; (viii) Allocation; (ix) Drop & Drag—Sort; (x) Visual Purchase History; (xi) Ranking; (xii) Video Selection; and (xiii) Multi-Sensory. A detailed description of each one of these survey modules 50 and the multimedia components utilized by these survey modules to collect research data follows.

1. Single Response—Real Time Feedback 84

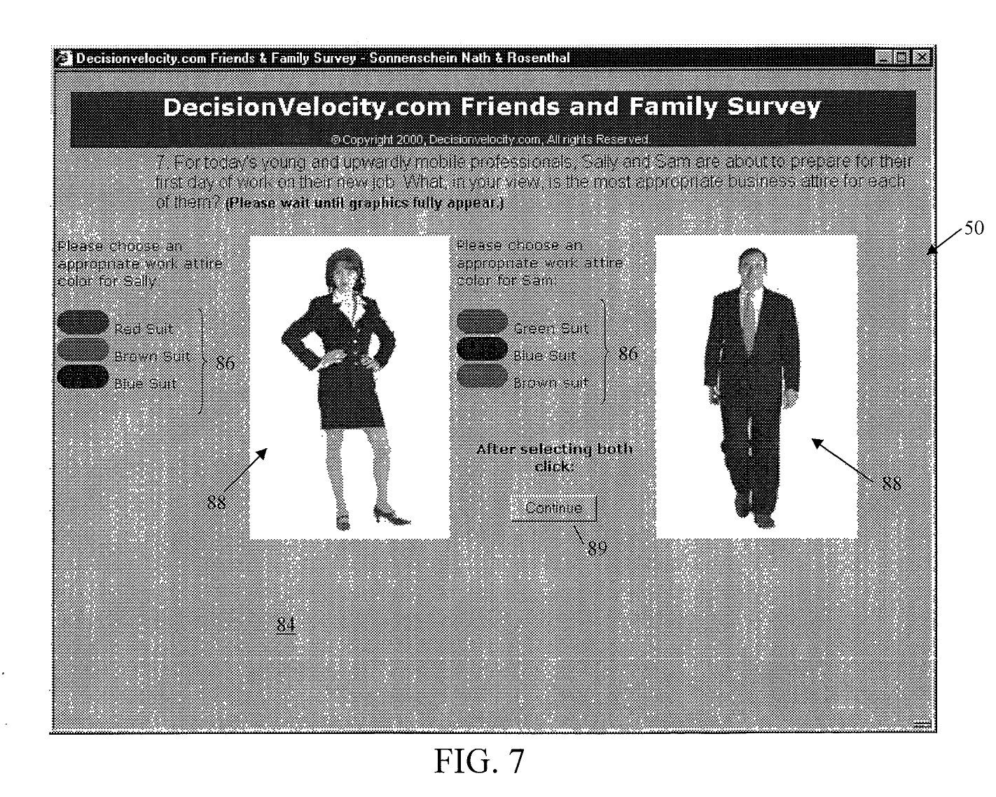

FIG. 7 illustrates a survey module 50 of one embodiment of the present invention having two single response interactive modules on one Web page that provides for real time feedback to the Participant. This type of module 50 shall be referred to herein as a Single Response, Real Time Feedback module 84. As seen in FIG. 7, a Single Response, Real Time Feedback interactive module 84 allows the Participant to select from a menu of selections 86 that will change the appearance of a graphic or subject 88 upon the selection and de-selection of a menu item 86. Depending on which menu selection 86 is highlighted, the appearance of the subject 88 will change. Each selection 86 corresponds to a layer that is used to change a characteristic of the subject 88. Thus, upon marking a selection 86, all layers that do not relate to the selection are hidden.

For example, as shown in FIG. 7, a Participant is provided with three color choices that when selected vary the color of a woman or man's suit. If the Participant selects the red suit, the graphical layers that represent the other color selections are hidden such that the red layer is displayed, giving the appearance of the woman wearing a red suit. To hide the red layer and view another layer, red is deselected in favor of another color. Once the Participant is satisfied with his or her selection, the Participant can press the continue button 89 to proceed to the next module.

The Single Response, Real Time Feedback module 84 provides real time feedback to the Participant in response to the Participant's preference. The visual representation of the subject 88 and the ability to modify the appearance of the subject 88 according to the actual proposed subject 88 also provides for a more accurate response. For example, the actual proposed color hues can be displayed and can be varied based upon preference. This eliminates any discrepancy in one's mind, or between Participants, as to what shade of red one is asking about when posed with the question, “Do you prefer a red suit or a green suit on a woman?”.

Furthermore, the Single Response, Real Time Feedback module 84 can easily be modified to be a Multiple Response, Real Time Feedback module (not shown). A Multiple Response, Real Time Feedback module would allow the Participant to vary at least two different features or objects of a subject 88 using layers as set forth above. This would allow the Participant to vary the appearance of more than one object on a subject 48. The Administrator could then ascertain not only the Participant's preference with respect to one object, but also to ascertain the Participant's preference with respect to two objects used in conjunction with one another. For example, in FIG. 7, another menu selection bar 86 could be placed near the subject 88 that would select and deselect accessories that can be worn by either the man or woman 88 in conjunction with their suit. This would allow the Participant to select different accessories that they may find to correspond better with one color of the suit than another.

As with all of the survey modules 50 set forth in this description, a Participant's choice can initiate a skip pattern or his or her choice can be carried forward to customize the next module 50 based upon the Participant's indicated preferences.

2. Drop & Drag—Multiple Response 91

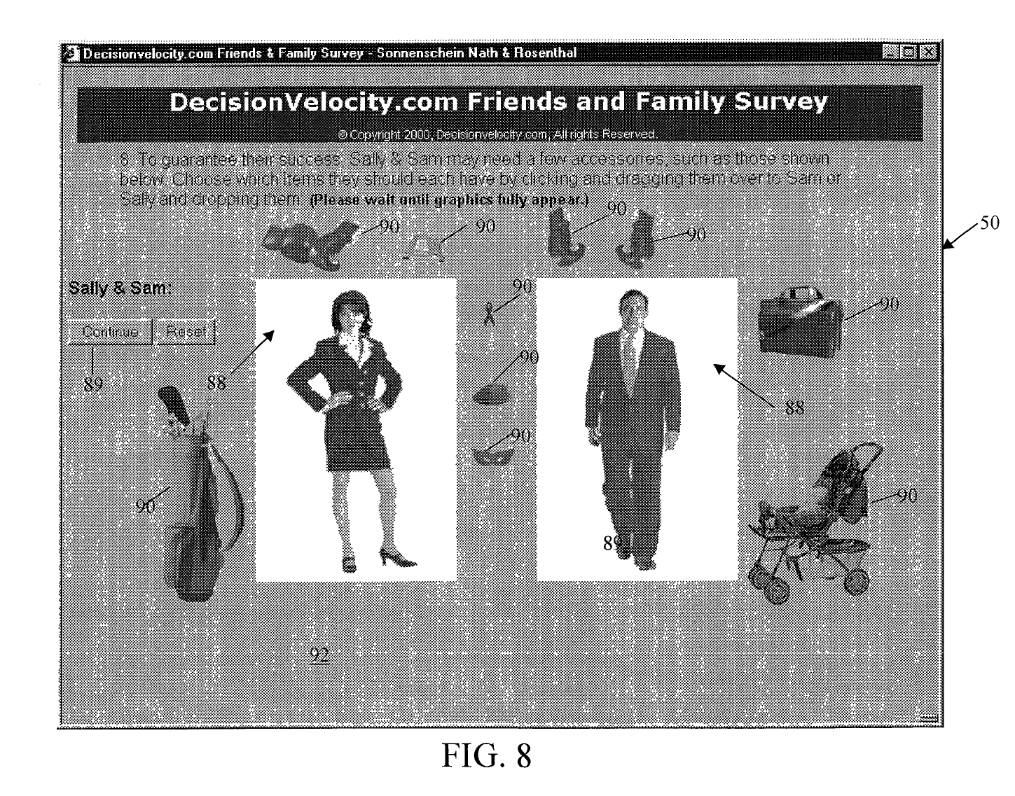

FIG. 8 illustrates a survey model 50 of one embodiment of the present invention that allows a user to drag and drop objects 90 as the Participant desires, which creates the ability for the Participant to give multiple responses by dragging and dropping multiple objects 90. This type of module shall be referred to herein as a Drop and Drag, Multiple Response module 92. As seen in FIG. 8, the Participant may be provided with two subjects 88. In an alternative embodiment, the Participant can be provided with one subject 88 or multiple subjects 88 with which to affiliate objects 90. A Participant is then asked affiliate one or more the objects 90 with a subject 88 by dragging those objects 90 and dropping them on the subjects 88. This will create an affiliation between each affiliated object 90 and its associated subject 88.

For example, as shown in FIG. 8, a Participant is provided with two subjects 88. These subjects are the same as the subjects illustrated in FIG. 7 in connection with the Single Response, Real Time Data module. Thus, this is an example of how a user preference can be carried forward to customize the next module 50. In this example, the suit color selected in the previous module 50 can be displayed in the subsequent module 50. A Participant is then asked to drop and drag objects 90 that Participant chooses to affiliate with a subject 93, in this case, a man or woman, and drop those objects 90 next to the subject 88.

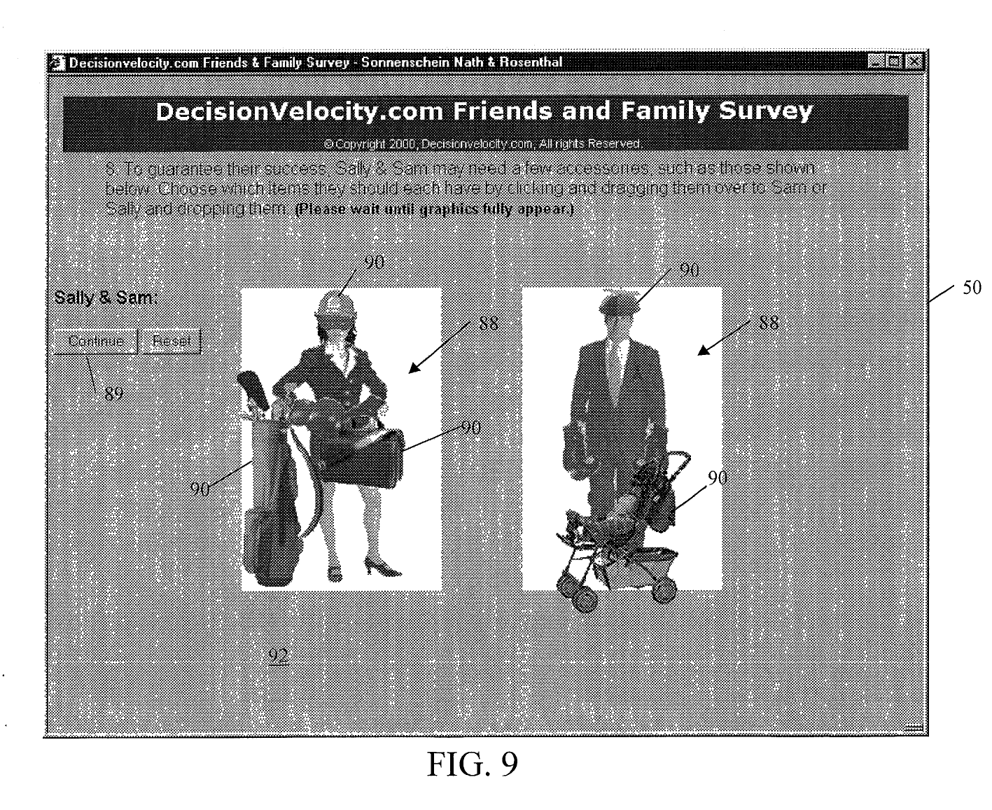

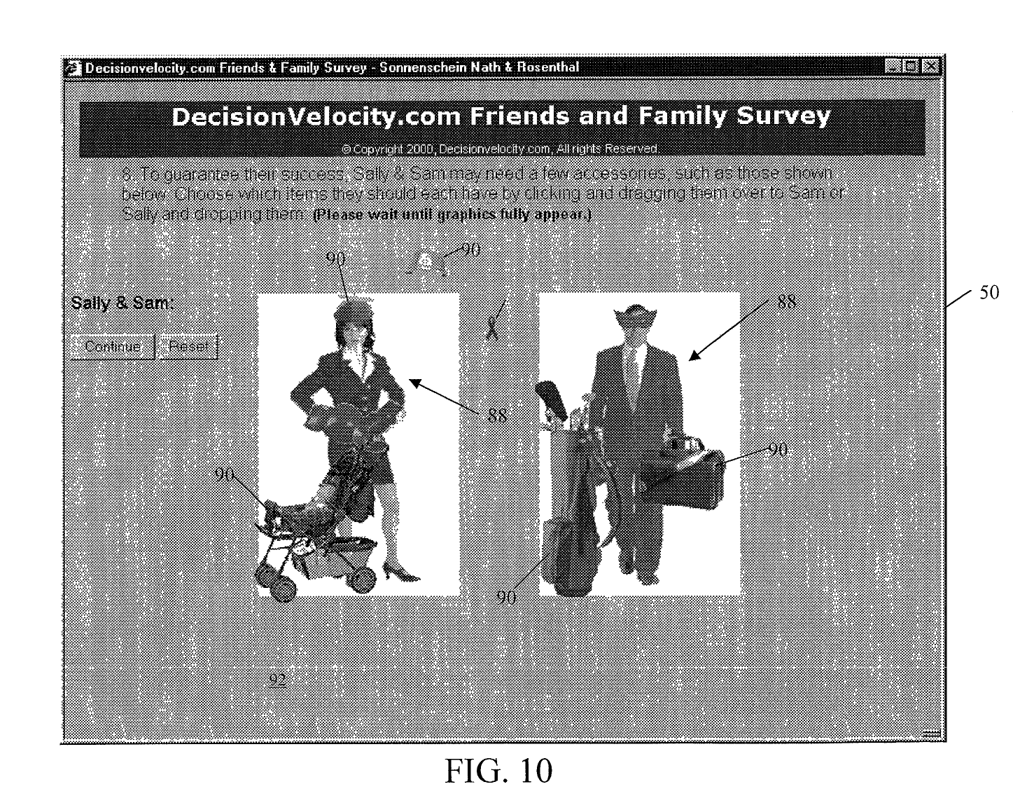

As seen in FIG. 9, all of the objects 90 can be affiliated with a subject 88. Alternatively, as illustrated in FIG. 10, the Participant may choose not to affiliate all of the objects 90 with a subject 88. Also as shown by a comparison of FIG. 9 and FIG. 10, some objects 90 may be affiliated with either subject 88, whereas other objects 90 may only be affiliated with one subject 88.

3. Slider Scale Response

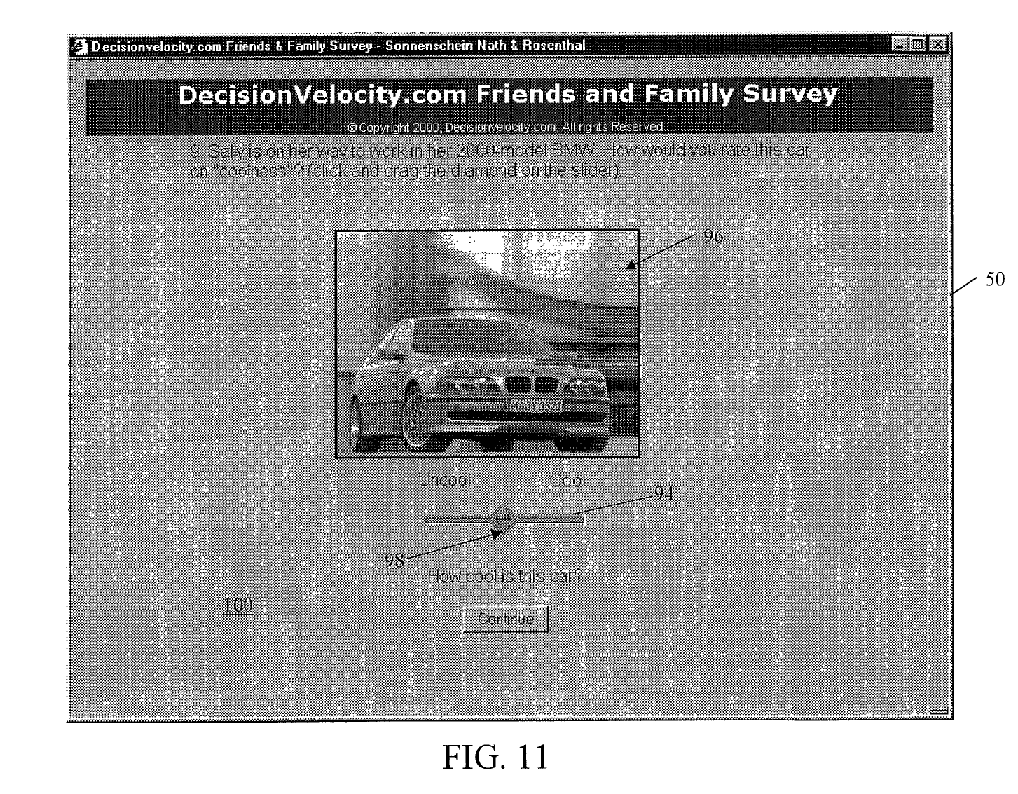

FIG. 11 illustrates an example of a module 50 which allows the Participant to gauge his reaction to a graphical display, audio clip, a video clip or other stimuli 96. Once the Participant has viewed or sensed the stimuli 96, the Participant then gauges his response by the utilization of a slider scale 94 as shown in FIG. 11. The bar 98 on the scale 94 is engaged by the Participant using his mouse and drug along the scale 94 and dropped into the position which represents the Participant's reaction to the stimuli 96. One example, as seen in FIG. 11, asks a Participant to gauge his or her reaction to a graphical depiction of a car 96. Upon viewing the car 96, the Participant is then asked to slide the bar 98 on the scale 94 either towards the “Cool” side or the “Uncool” side of the scale 94. This type of module is referred to herein as a Slider Scale Response 100 and may be used to gauge any type of interactive stimuli 96 such as graphics, streamline video, audio, a peripheral device designed to interact with the Participant or other stimuli 96.

4. Multiple Response—Interactive Checkbox

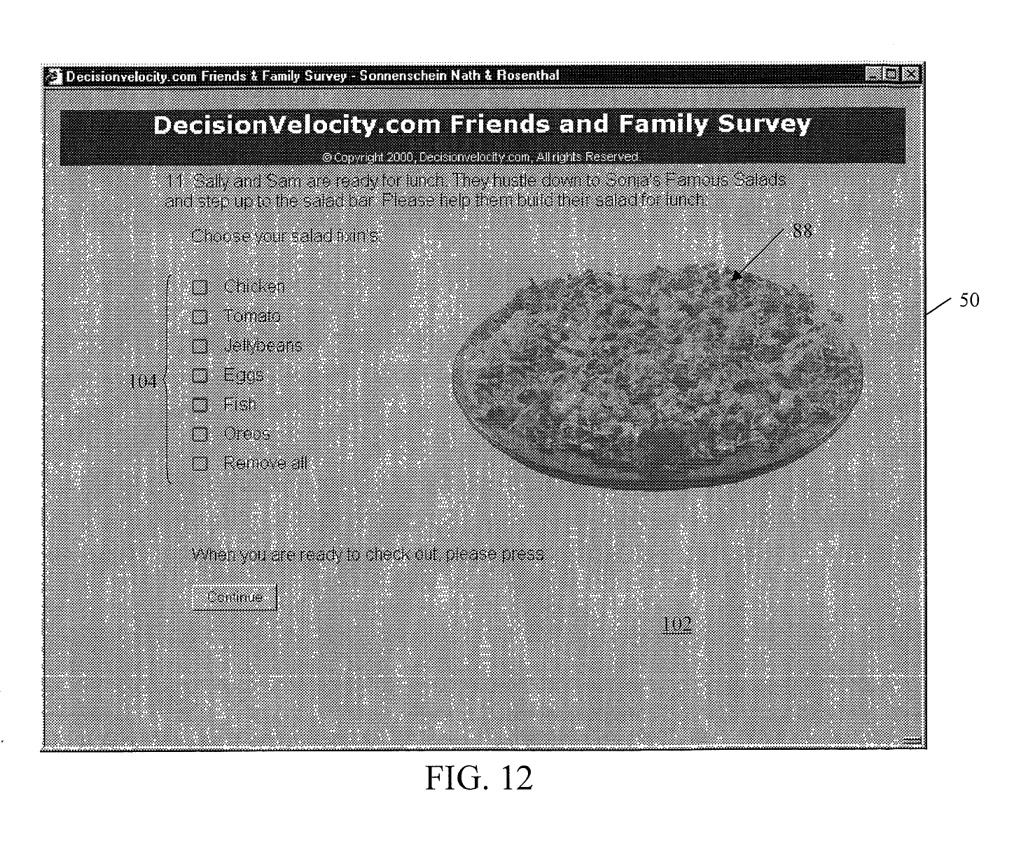

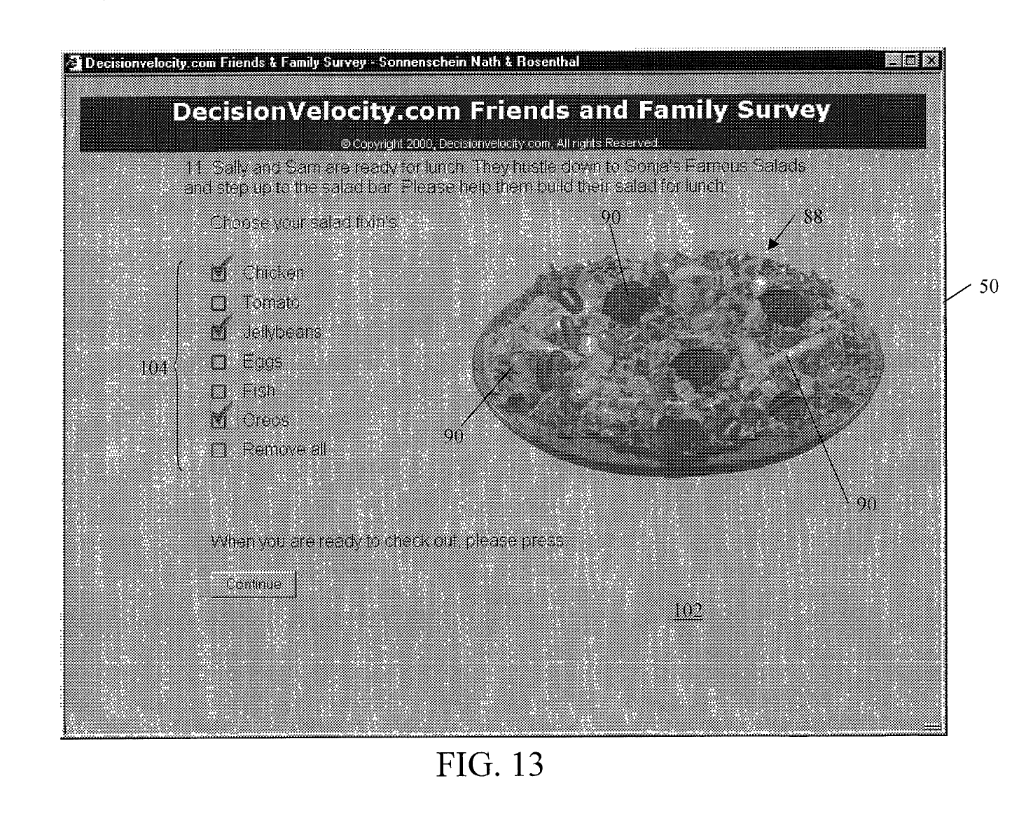

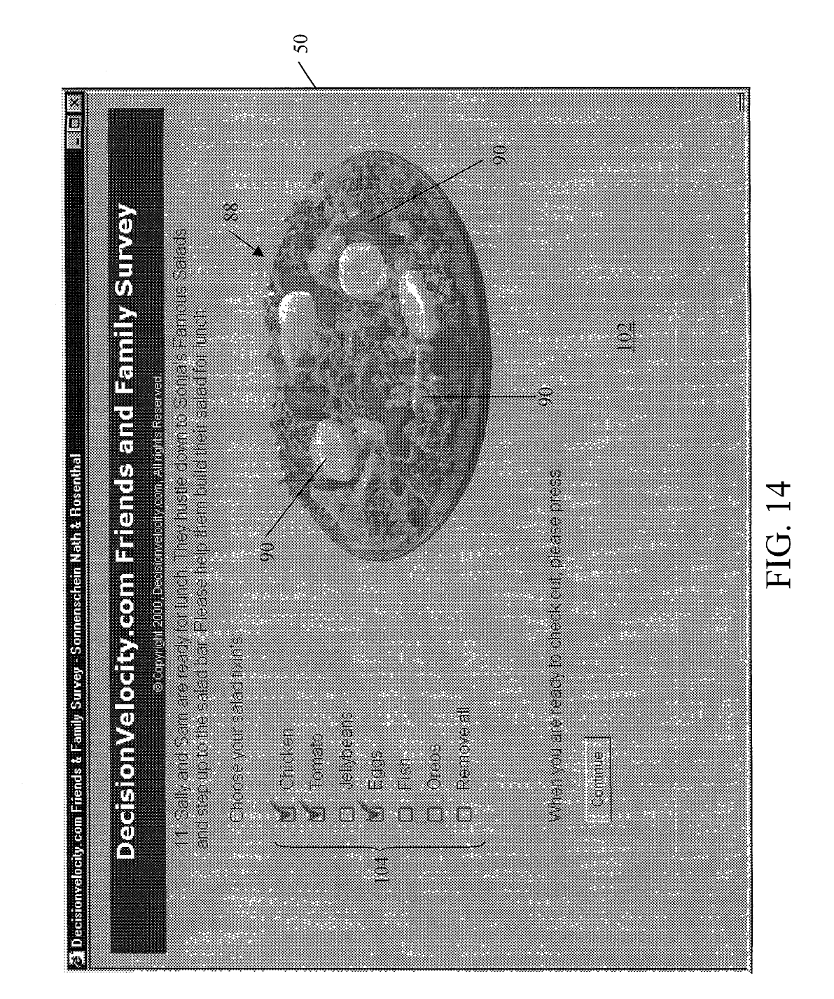

FIGS. 12 through 14 illustrate a module of one embodiment of the present invention that allows the user to add objects or items 90 to a particular subject 88. This type of module will be referred to herein as a Multiple Response, Interactive Checkbox module 102. As illustrated by FIGS. 12 through 14, a Participant is given a subject 88 and is asked to add items 90 to the subject in accordance with the Participant's preference. In the example given in FIGS. 12 through 14, a Participant is asked to build a salad by starting with a plate full of lettuce as the subject 88. Participant is then given a variety of menu selections 104 and has the option to select as many selections 104 as the Participant prefers. As shown in FIG. 13, the Participant has selected chicken, jelly beans and Oreos as salad toppings. The fixings again are layers which are initially hidden and upon the selection of the menu item 104, the layer is unhidden for view by the Participant. Thus, in FIG. 13, because the Participant selected chicken, jelly beans and Oreos, the layers that correspond to the visual representations of chicken, jelly beans and Oreos are unbidden. FIG. 14 shows an alternative selection of chicken, tomatoes and eggs. Thus, when the boxes corresponding to chicken, tomatoes and eggs are selected, the layers which correspond in visual representation to chicken, tomatoes and eggs are unhidden for viewing by the Participant.

5. Multiple Response—Custom Calculation Features

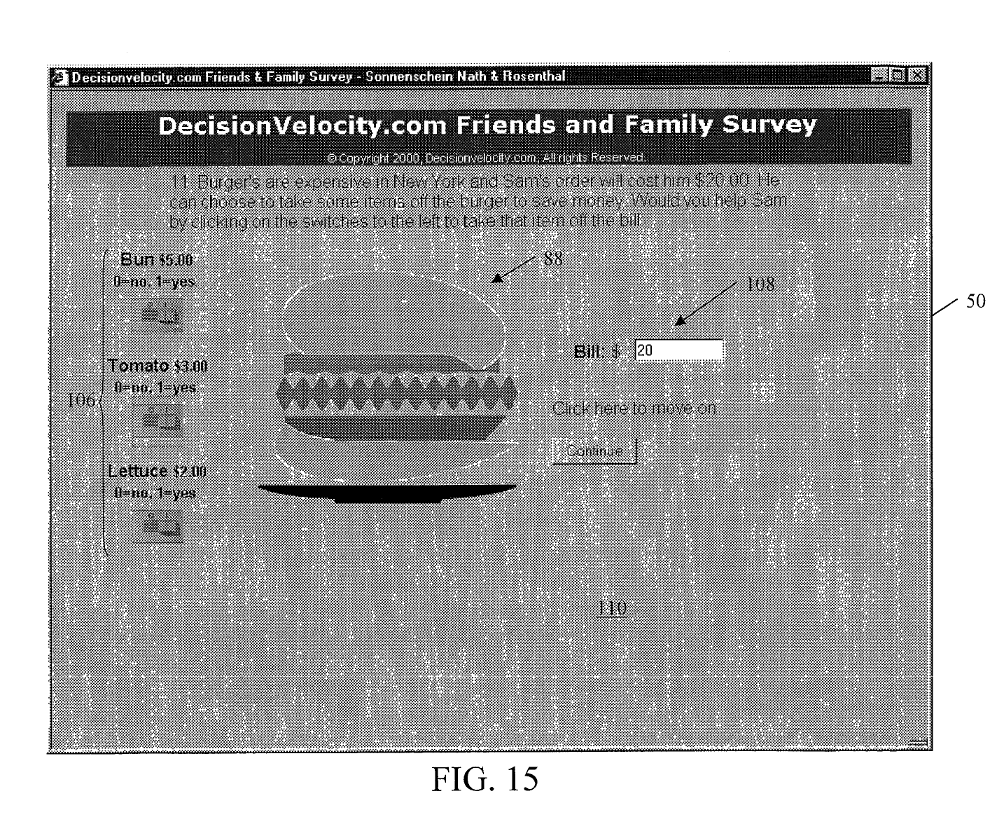

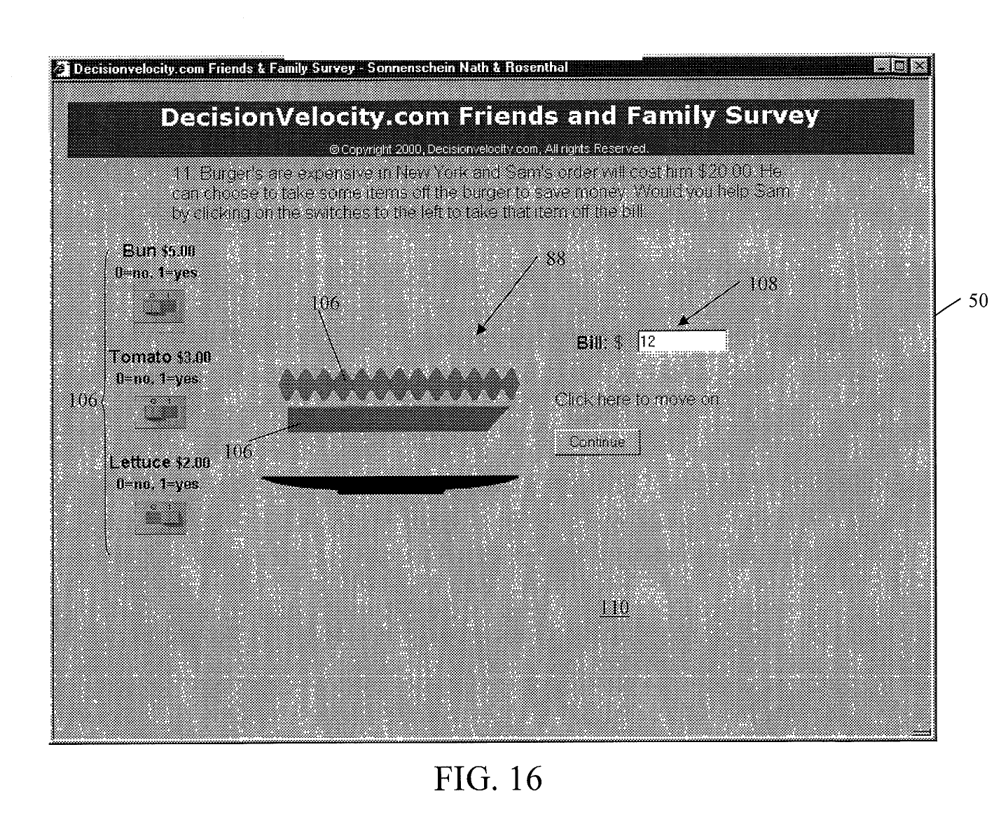

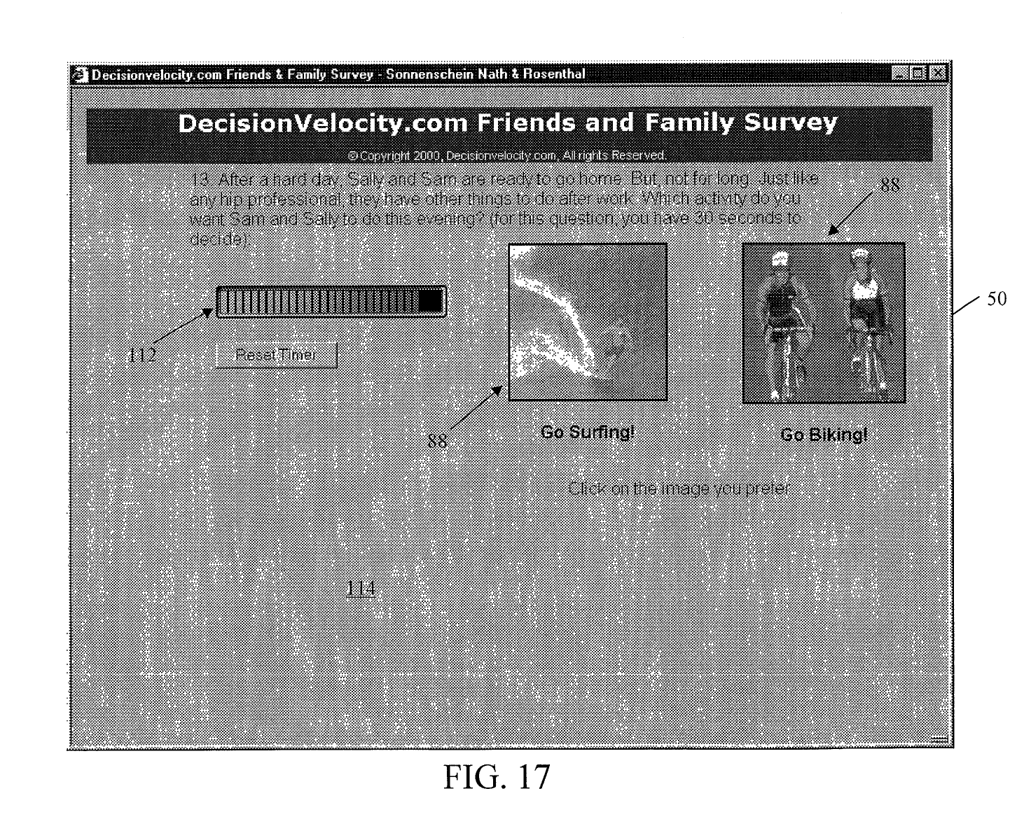

FIG. 15 illustrates a subject 88 with multiple variables 106 that are tied to a dollar value 108. This type of module 50 shall be referred to herein as a Multiple Response, Custom Calculation Features module 110. The Multiple Response, Custom Calculation Feature module 110 allows a Participant to select and deselect variables 106 of the subject 88 and upon deselection or selection of such variables 106, the calculation of the dollar value 108 associated with the subject 88 is altered. For example, in FIG. 15, a Participant is presented with a hamburger 88 with the variables 106 of a bun, tomato and lettuce. The dollar value 108 of the subject hamburger 88 will vary. FIG. 16 illustrates an example of the module 110 where two variables 106 are selected such that only the selected variables 106 are viewed by the Participant. Upon deselection of variables 106, the dollar value 108 associated with the subject 88 decreases. As seen in FIG. 16, the Participant deselected the bun and the tomato, leaving only the lettuce and the meat which reduced the value 108 of the subject hamburger 88 to $12.00. Of course, as would be understood by those skilled in the art, the number of selection variables is dependent upon the survey issue being probed by a particular inquiry or set of inquiries.

6. Timer Interaction

FIG. 17 illustrates a survey module 50 of one embodiment of the present invention that asks the Participant to select between two or more stimuli or subjects 88 within a predesignated amount of time. As shown in FIG. 17, a timer 112 is displayed that shows the Participant how long her or she has to select his or her preference. In one embodiment, if the timer 112 expires, the survey advances to the next module 50. This type of module shall be known herein as a Timer Interaction module 114.

7. Drop & Drag—Variable Scale Response

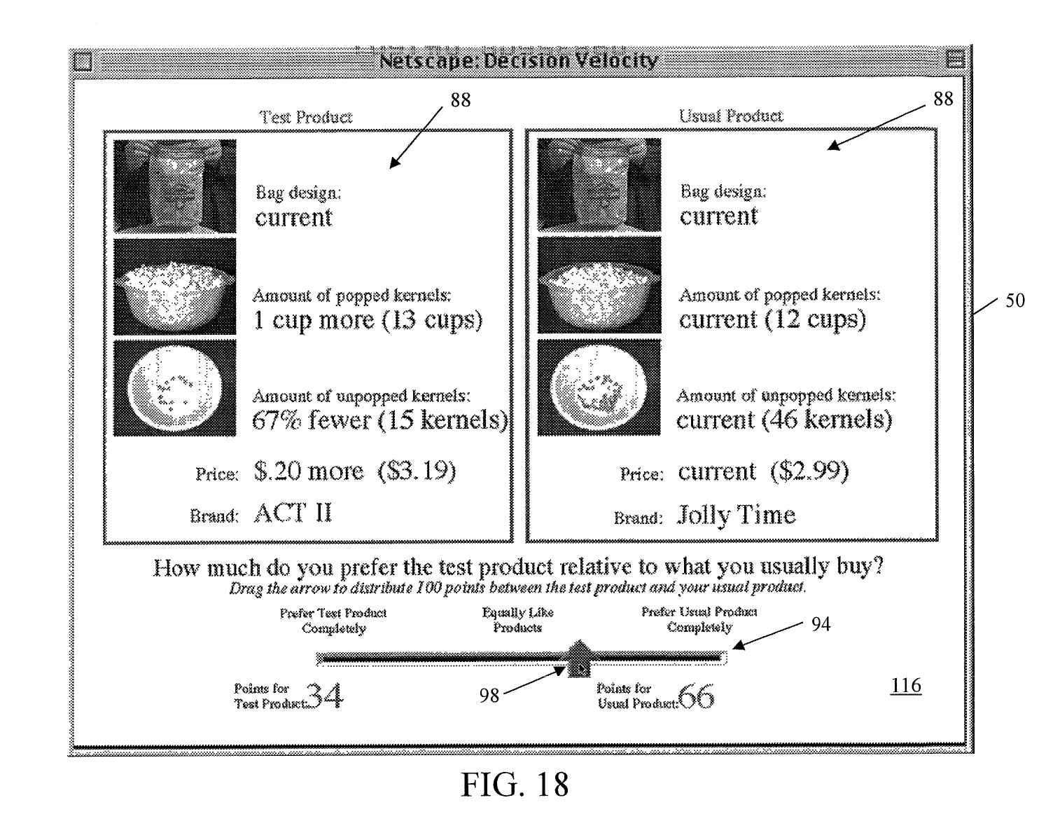

FIG. 18 illustrates a modified Slider Scale Response module 100 that asks a Participant to use a sliding scale 94 to compare at least two subjects or stimuli 88. As shown in FIG. 18, as the button 98 on the scale 94 is moved in one direction the rating for one subject 88 increases, while the rating for the other subject 88 decreases. This type of module shall be known herein as a Drop & Drag—Variable Scale Response 116.

8. Allocation

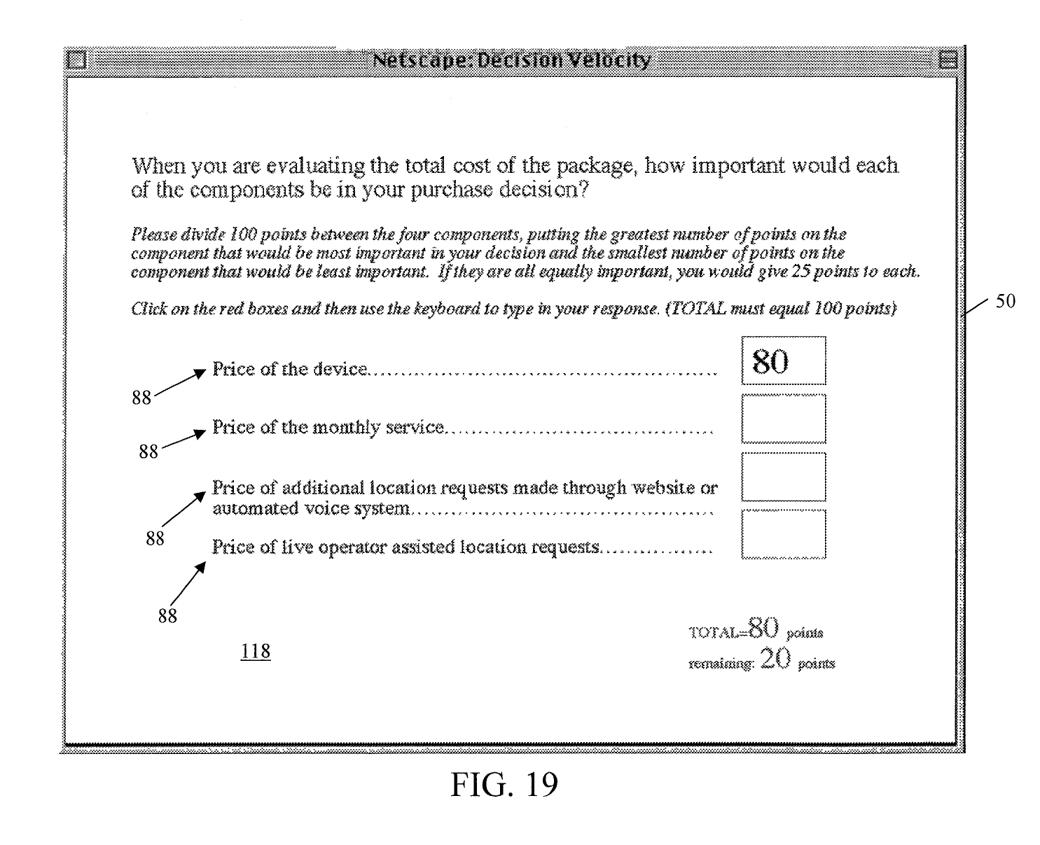

FIG. 19 illustrates a survey module 50 of one embodiment of the present invention that asks the Participant to allocate a total number of points between at least two different subjects 88 or items of comparison such that the total allocation between the subjects 88 equal a whole. While FIG. 19 asks a Participant to use numbers as a means of allocation, the Administrator could use other means for allocating between the items, such as coins, chips, or any other measure of quantity. This type of survey module will be referred to herein as an Allocation module 118.

9. Ranking

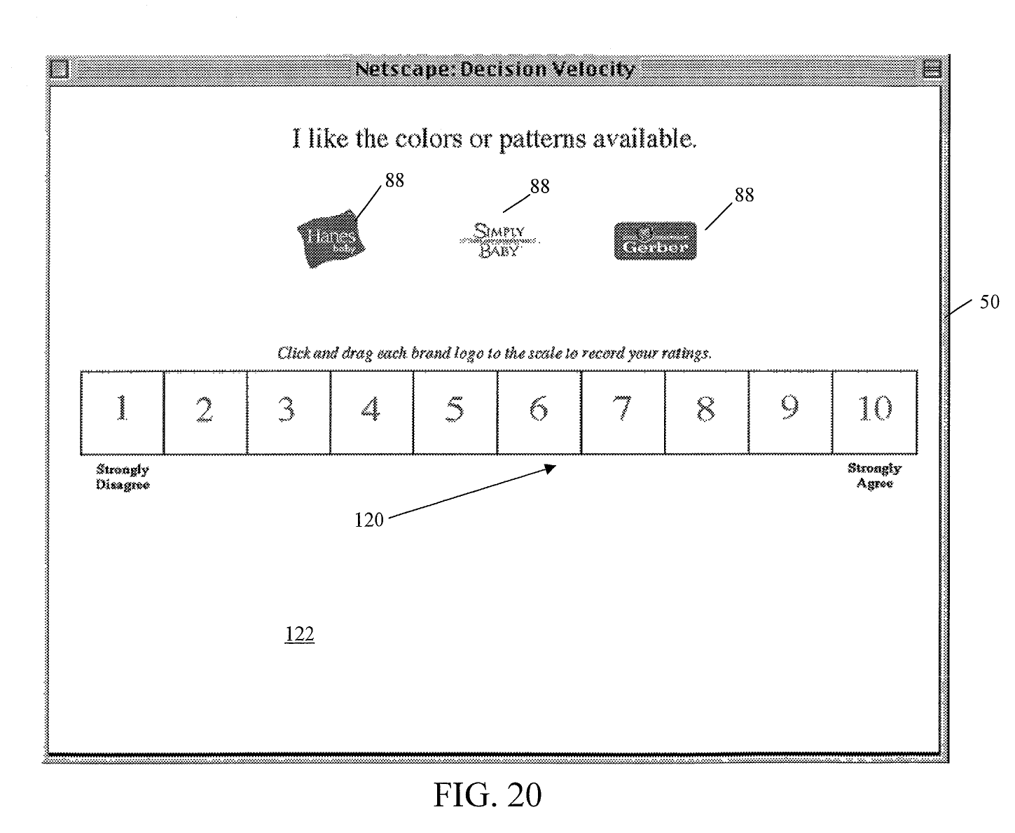

FIG. 20 illustrates a survey module 50 of one embodiment of the present invention that asks a Participant to rank order at least two subjects 88 relative to one another by dragging the subjects 88 to a scale 120 and dropping the subjects 88 along the scale 120 at a position that is relative to the subject's 88 comparative rank. This type of survey module 50 shall be referred to herein as the Ranking module 122.

10. Visual Purchase History

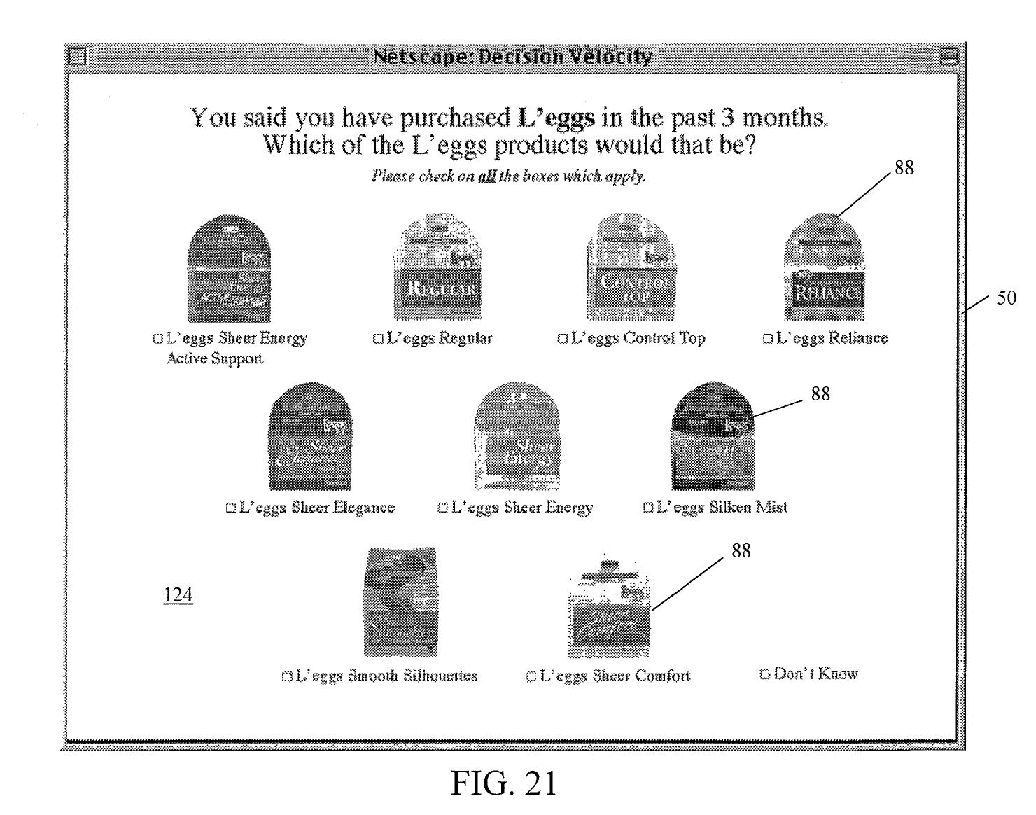

FIG. 21 illustrates a survey module 50 of one embodiment of the present invention that depicts products or subjects 88 to determine a Participant's purchase history. This type of module 50 shall be referred to herein as the Visual Purchase History module 124. An example of such Visual Purchase History module 124 is illustrated in FIG. 21, which depicts one type of product 88 as it would appear on the shelf. This visual depiction assists a Participant with recalling and determining what he or she has purchased in the past or typically purchases or prefers and increases the accuracy of a Participant's response.

11. User Preference

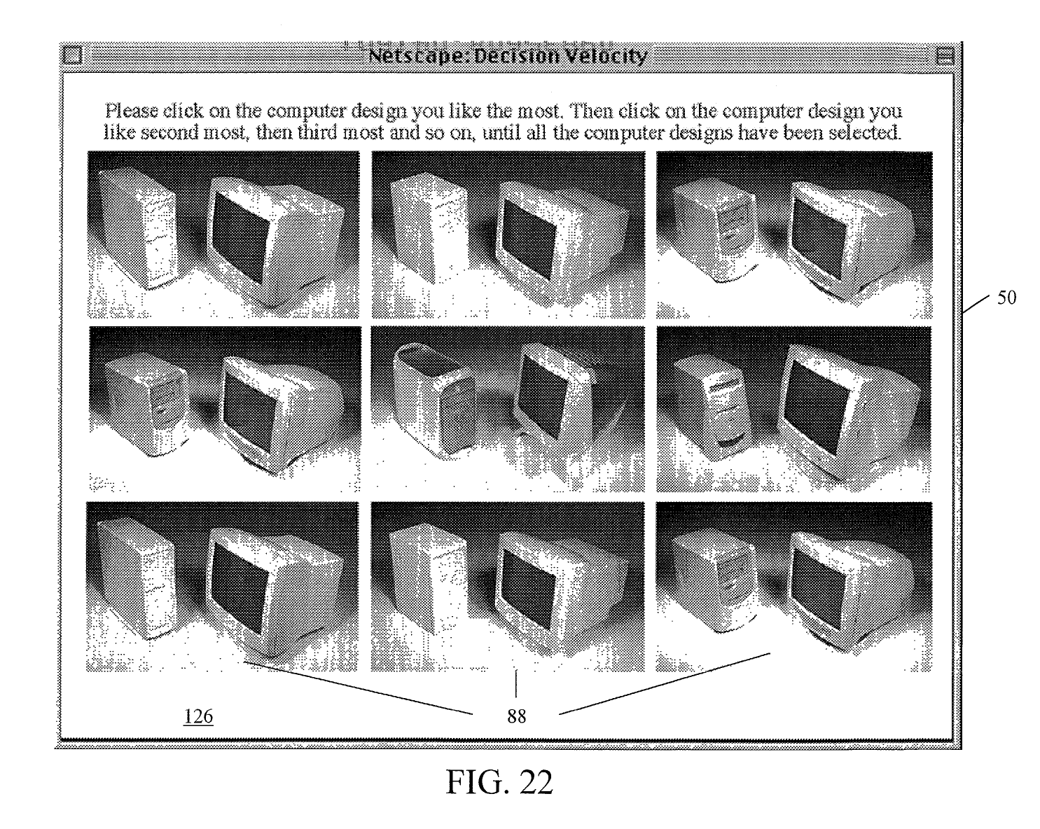

FIG. 22 illustrates a survey module 50 of one embodiment of the present invention that depicts design variations for a particular product or subject 88 and asks a Participant to select the design that the Participant prefers. This type of module 50 shall be referred to herein as the User Preference module 126. A User Preference module 126 could be designed to record Participant's favorite design, or could be designed to ask a Participant to select the designs in order of preference, as illustrated by FIG. 22. In one embodiment, the design variations will become hidden from the Participant upon selection. In another embodiment, the module 126 would put a numeric value or other marker with the selection based upon the order of selection. One skilled in the art will recognize other methods for designating and recording the order of selection.

12. Drop & Drag—Sort

FIG. 23 illustrates a survey module 50 of one embodiment of the present invention that asks a Participant to sort objects 90 by dragging the objects 90 and dropping them in different, pre-designated areas 128 of the Web Page. This type of the module is referred to as a Drop & Drag, Sort module 130. A Drop & Drag, Sort module 130 can be used to determine visual likeness or to categorize objects 90 from the visual prospective of a Participant.

13. Video Selection

While not illustrated in any of the figures, streaming video and audio can also be used as the stimuli or subject 88 of a module 50. To gather responses, the video may also be paused at either the Participant's request or by design of the Administrator. Likewise, still pictures may be taken from stream video, at either the Participant's request or the Administrator's design. These still pictures can then be manipulated or become the subject 88 of other components of the module 50.

14. Multi-Sensory

To engage the senses of a Participant through means other than sight and sound, peripheral devices attached to the client's computer may be used to emit odor or imitate the texture of an object upon the request of the survey software application.

D. Multi-tier Web Site Computer Systems

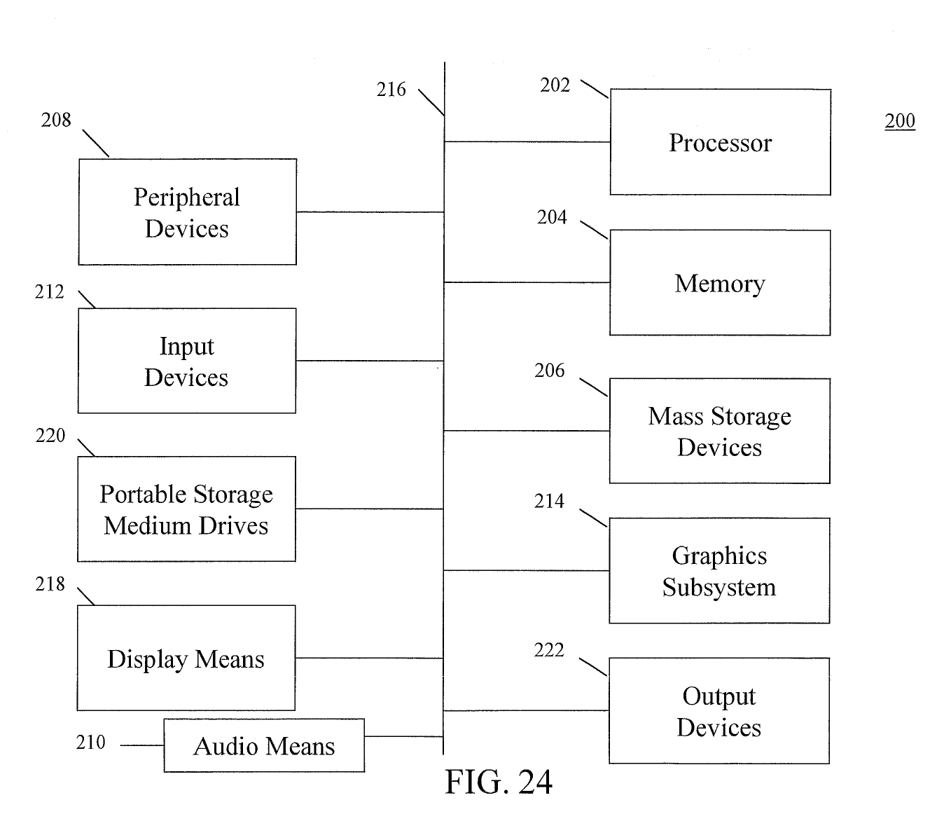

FIG. 24 illustrates a high-level block diagram of a general purpose computer system which is used, in one embodiment, to implement the method and system of the present invention. The general purpose computer acts as either the server 38 or client 32 (i.e., Participant and Administrators computer) of FIGS. 1 and 2. The general purpose computer 200 of FIG. 24 includes a processor 202 and memory 204. The processor 202 may contain a single microprocessor, or may contain a plurality of microprocessors. Memory 204 stores, in part, instructions and data for execution by processor 202. If the system of the present invention is wholly or partially implemented in software, including computer instructions, memory 204 stores the executable code when in operation. Memory 204 may include banks of dynamic random access memory (DRAM) as well as high speed cache memory.

The computer of FIG. 24 further includes a mass storage device 206, peripheral device(s) 208, audio means 210, input device(s) 212, portable storage medium drive(s) 220, a graphics subsystem 214, and a display means 218. For purposes of simplicity, the components shown in FIG. 24 are depicted as being connected via a single bus 216 (i.e., transmitting means). However, the components may be connected through one or more data transport means (e.g., Internet, Intranet, etc.). For example, processor 202 and memory 204 may be connected via a local microprocessor bus, and the mass storage device 206, peripheral device(s) 208, portable storage medium drive(s) 220, and graphics subsystem 214 may be connected via one or more input/output (I/O) buses. Mass storage device 206, which is typically implemented with a magnetic disk drive or an optical disk drive, is in one embodiment, a non-volatile storage device for storing data and instructions for use by processor 202. In another embodiment, mass storage device 206 stores the components of the server 38. In another embodiment, the storage device may also be the mass storage device 206. The computer instructions that implement the method of the present invention also may be stored in processor 202.

Portable storage medium drive 220 operates in conjunction with a portable nonvolatile storage medium, such as a floppy disk, or other computer-readable medium, to input and output data and code to and from the computer system of FIG. 24. In one embodiment, the method of the present invention that is implemented using computer instructions is stored on such a portable medium, and is input to the computer system 200 via the portable storage medium drive 220. Peripheral device(s) 208 may include any type of computer support device, such as an input/output (I/O) interface, to add additional functionality to the computer system 200. For example, peripheral device(s) 208 may include a network interface card for interfacing computer system 200 to a network, a modem, and the like.

Input device(s) 212 provide a portion of a user interface. Input device(s) 212 may include an alpha-numeric keypad for inputting alpha-numeric and other key information, or a pointing device, such as a mouse, a trackball, stylus or cursor direction keys. In order to display textual and graphical information, the computer 200 of FIG. 24 includes graphics subsystem 214 and display means 218. Display means 218 may include a cathode ray tube (CRT) display, liquid crystal display (LCD), other suitable display devices, or means for displaying. Graphics subsystem 214 receives textual and graphical information and processes the information for output to display 218. Additionally, the computer of FIG. 24 includes output devices 222. Examples of suitable output devices include printers, and the like.

The devices contained in the computer system of FIG. 24 are those typically found in general purpose computers, and are intended to represent a broad category of such computer components that are well known in the art. The system of FIG. 24 illustrates one platform which can be used for practically implementing the method of the present invention.

In a further embodiment, the present invention also includes a computer program product which is a computer readable medium (media) having computer instructions stored thereon/in which can be used to program a computer to perform the method of the present invention. The storage medium can include, but is not limited to, any type of disk including floppy disks, optical disks, DVD, CD ROMs, magnetic optical disks, RAMs, EPROM, EEPROM, magnetic or optical cards, or any type of media suitable for storing electronic instructions.

These same computer instructions may be located in an electronic signal that is transmitted over a data network that performs the method of the present invention when loaded into a computer. The computer instructions are in the form of data being transmitted over a data network. In one embodiment, the method of the present invention is implemented in computer instructions and those computer instructions are transmitted in an electronic signal through cable, satellite or other transmitting means for transmitting the computer instructions in the electronic signals.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems and user applications. Ultimately, such computer readable media further includes software for performing the method of the present invention as described above.

Although the present invention has been described in detail with respect to certain embodiments and examples, variations and modifications exist which are within the scope of the present invention as defined in the following claims.

What is claimed is:

1. A method for conducting market research by collecting real time responses from a participant, comprising:
providing a browsable Web site accessible by said participant through a communications link;
initiating an electronic survey when said participant accesses said Web site, said survey including a series of Web pages;
allowing said participant to interact with said Web pages through multimedia tools;
generating data based upon each of said interactions with said Web pages;
ending said survey; and
storing said data in an electronic file after ending said survey.

2. The method of claim 1 wherein said multimedia tools includes at least one said multimedia tool selected from the group consisting of: a single response real time feedback module, a multiple response real time feedback module, drop and drag objects, a slider scale response, a multiple response interactive checkbox, a multiple response custom calculation feature, a timer interaction, a drop and drag variable scale response, an allocation, a ranking, a visual purchase history, a user preference, a drop and drag sort response, a video selection, a multi-sensory response, and a multi-tier web site computer system.

3. The method of claim 1, wherein said electronic survey further comprises a customized frame set having a main frame for displaying said series of Web pages and a hidden frame for storing said score from each said Web page until said participant completes said electronic survey.

4. The method of claim 1, further comprising an outer layer applied to each said Web page to prevent said participant from interacting with the survey until each said Web page is fully loaded on the Web site.

5. The method of claim 4 wherein said outer layer is the same color as a background color of each said Web page.

6. A method for collecting market research data from a participant, comprising:
providing an electronic application accessible by said participant through a computer, said computer including a memory unit;
initiating an electronic survey when said participant accesses said application, said survey including a series of electronic pages;
allowing said participant to interact with said electronic pages through multimedia tools;
generating a score based upon said interaction with said electronic pages;
ending said survey after said participant interacts with each of said series of electronic pages; and
storing said score in said memory unit after ending said survey.

7. The method of claim 6 wherein said multimedia tools includes at least one said multimedia tool selected from the group consisting of: a single response real time feedback module, a multiple response real time feedback module, drop and drag objects, a slider scale response, a multiple response interactive checkbox, a multiple response custom calculation feature, a timer interaction, a drop and drag variable scale response, an allocation, a ranking, a visual purchase history, a user preference, a drop and drag sort response, a video selection, a multi-sensory response, and a multi-tier web site computer system.

8. The method of claim 6, wherein said electronic survey further comprises a customized frame set having a main frame for displaying said electronic pages to allow interaction with said participant and a hidden frame for storing each said score from each said electronic page until said participant completes said survey.

9. The method of claim 6, further comprising an outer layer applied to each said electronic page to prevent said participant from interacting with the survey when each said electronic page is loading on said computer.

10. The method of claim 9 wherein said outer layer is the same color as a background of each said Web page.

11. The method of claim 6, further comprising the step of automatically transmitting said score from said computer through a communications link to a remote database after ending said survey.

12. A method for conducting market research by collecting real time responses from a participant, comprising:
(a) providing a browasable computer resource accessible by said participant through a communications link;
(b) initiating an electronic survey when said participant accesses said computer resource;
(c) allowing said participant to manipulate a graphical item as part of said electronic survey;
(d) generating data based upon said manipulation of said graphical item;
repeat (c) and (d) until the electronic survey is complete; and
(e) storing said data.

13. The method of claim 12 wherein said manipulation is selected from the group comprising rotating, magnifying, moving, and visually changing said graphical item.

14. The method of claim 12 wherein said electronic survey further includes additional stimuli perceivable by the user.
